(19) United States
(12) Patent Application Publication
(10) Pub. No.: US 2013/0318857 A1
(43) Pub. Date: Dec. 5, 2013

(54) Artificial Bait Device

(71) Applicant: Derrell Daniel, Andalusia, AL (US)

(72) Inventor: Derrell Daniel, Andalusia, AL (US)

(21) Appl. No.: 13/905,508

(22) Filed: May 30, 2013

Related U.S. Application Data
(60) Provisional application No. 61/652,940, filed on May 30, 2012.

(51) Int. Cl. A01K 85/00

(52) U.S. Cl. CPC A01K 85/00
USPC 43/42.09; 43/42.25

(57) ABSTRACT

An artificial bait device for fishing that allows a user to attach a plastic or soft artificial bait is disclosed. The artificial bait device comprises a snake-shaped jig head and a hook that does not become easily snagged and can maintain a consistent depth. The artificial bait device further comprises a lip that allows the device to maintain different depths depending on a design of the lip.

### CROSS-REFERENCE

This application claims priority from Provisional Patent Application Ser. No. 61/652,940 filed May 30, 2012.

### FIELD OF THE INVENTION

This invention pertains generally to an artificial bait device that allows a user to attach a plastic or soft artificial bait to the artificial bait device, and more particularly to an artificial fishing jig head that does not become easily snagged and can maintain a consistent depth.

### BACKGROUND

Fishermen and fisherwomen often use plastic or artificial worm baits. However, these artificial baits can look unnatural and be ineffective in baiting fish creating an additional investment in other types of artificial baits. Existing artificial baits are susceptible to becoming entangled in thick vegetation and submerged hazards, such as roots, branches, rocks, trash, and the like, because the user experiences difficulty in controlling the depth of the bait. Once entangled, the bait is either lost or ineffective as bait until reeled in and recast.

Consequently, there exists a need for a device to provide a more realistic artificial bait having a life-like appearance and providing realistic movement in the water. The present invention discloses a device for use with existing artificial baits such as swimming worms and other soft plastic bait. Attachments for the device may allow a user to employ different color combinations for attracting a variety of different fish under a variety of different fishing conditions. The device allows a user to achieve a consistent depth of the artificial bait in water while the bait is reeled in, and still avoid snags. The device may be used as a top running or floating bait, a shallow depth bait, or a diving bait.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an artificial bait device useable with a variety of existing soft plastic baits such as worms, grubs, and the like. The artificial bait device comprises a snake-shaped jig head, a lip extending forward from the snake-shaped jig head, and a hook extending rearward from the snake-shaped jig head. The lip may comprise a plurality of angles that will allow the artificial bait device to maintain different depths when reeled through the water. The hook terminates in a barb substantially in-line with a portion of the hook that extends rearward out of the snake-shaped jig head to help avoid snags.

Furthermore, in a preferred embodiment of the artificial bait device, an upward angled lip extends from a front portion of the snake-shaped jig head allowing the artificial bait device to essentially float on the surface of the water when reeled. In another preferred embodiment, the artificial bait device comprises an angled lip comprising a downward angled portion and a substantially level portion extending forward from the downward angled portion which allows the artificial bait device to dive and maintain a shallow depth when reeled. In another preferred embodiment, the artificial bait device comprises a downward angled lip which allows the artificial bait device to dive and maintain a deeper depth when reeled.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an exploded view of an artificial bait device in accordance with the disclosed architecture.

FIG. 2 illustrates a perspective view of the artificial bait device in accordance with the disclosed architecture.

FIG. 3 illustrates a perspective view of the artificial bait device with an upward angled lip in accordance with the disclosed architecture.

FIG. 4 illustrates a perspective view of an artificial bait device with a lip comprising a downward angled portion and a substantially level portion in accordance with the disclosed architecture.

FIG. 5 illustrates a perspective view of an artificial bait device with a downward angled lip in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter. The invention relates generally to an artificial bait device for catching fish that has a realistic appearance and provides realistic movement in the water.

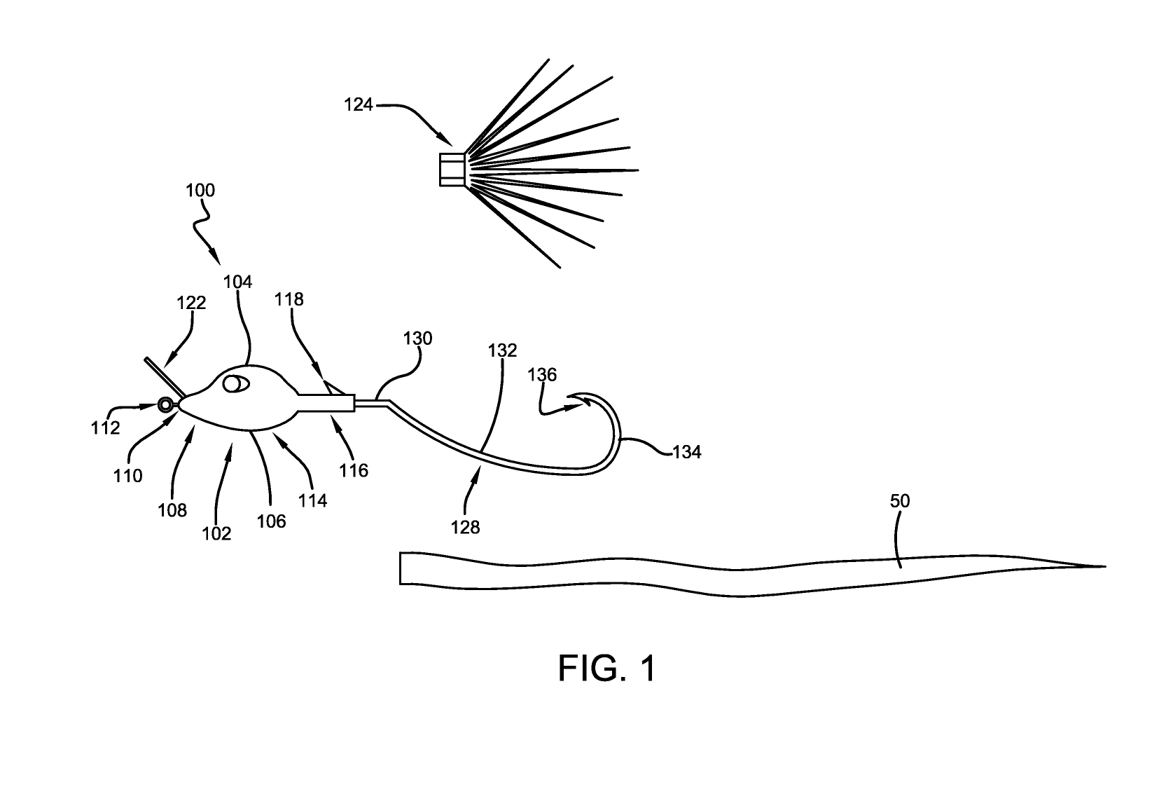

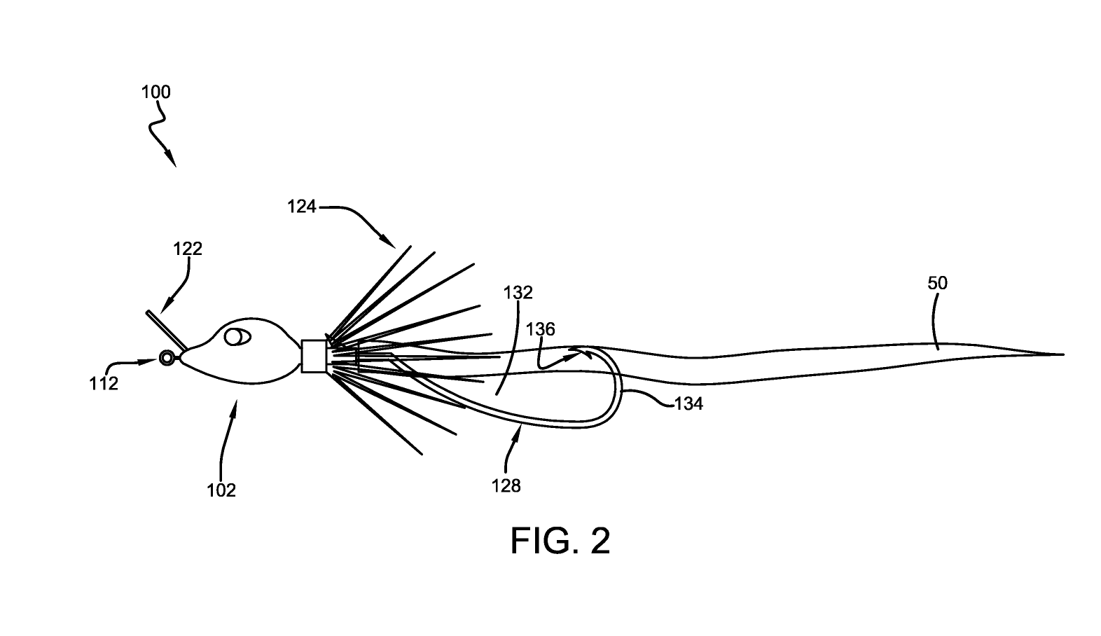

Referring initially to the drawings, FIGS. 1 and 2 illustrate an artificial bait device 100 for use with a soft plastic bait 50. The artificial bait device 100 is typically a fishing jig head having the appearance of a snake's head. The artificial bait device 100 comprises a snake-shaped jig head 102, a lip 120, a jig shirt 124, and a hook 128, or any other suitable shape as is known in the art. The snake shaped jig head 102 is typically formed from a rigid plastic, although it is contemplated that the snake shaped jig head 102 may comprise a light metal as well without affecting the overall scope of the invention. The soft plastic bait 50 may comprise worms, grubs, crayfish, insects, frogs, larvae, and the like, or any other existing soft plastic bait as is known in the art.

The snake-shaped jig head 102 comprises a top 104, a bottom 106, a front portion 108, a middle portion 114, and a rear portion 116. The front portion 108 is generally flatter and narrower than the middle portion 114 so as to assume the general shape of a snake's head. Similarly, the front portion 108 is slightly beveled on the top 104 adding to the appearance. The front portion 108 further terminates in a nose 110 comprising an eyelet 112 extending forward out of the snake-shaped jig head 102 for attaching to a fishing line (not shown). This head shape has been found to be beneficial as it remains upright and easily glides through water plants when reeled.

The rear portion 116 is essentially a cylindrical protuberance extending rearwardly from the middle portion 114. The rear portion 116 comprises a bait attachment point 118. The bait attachment point 118 is typically a barb that will attach to and hold one end of the soft plastic bait 50. With the soft plastic bait 50 attached to the bait attachment point 118, the artificial bait device 100 will resemble a live bait corresponding to the type of the soft plastic bait 50 used.

The jig skirt 124 comprises a collar that fits over and is also held in place by the bait attachment point 118. The jig skirt 124 further comprises a plurality of strands that extend rearwardly from the rear portion 116 of the snake-shaped jig head 102. The jig shirt 124 is essentially a weed guard made from rubber, although it may also comprise any other material as is known in the art. Rubber is preferable, as it allows the jig skirt 124 to change shape as the artificial bait device 100 wobbles in the water when reeled in. Furthermore, the jig shirt 124 may comprise a spinning element (not shown) for creating vibrations in the water when the artificial bait device 100 is reeled in.

The hook 128 is typically a light wire fishing hook preferably between 2/0 and 4/0, although larger and smaller hooks may be used without varying from the scope of the invention. The hook 128 comprises a straight portion 130, a downwardly angled portion 132, an upwardly curved portion 134, and a barb 136. The hook 128 is also upward facing so that the barb 136 may penetrate the soft plastic bait 50 to help hold it in place and to avoid snags. The straight portion 130 is embedded within and extends rearwardly out of the rear portion of the snake-shaped jig head 102. The straight portion 130 extends into the downwardly angled portion 132 which extends into the upwardly curved portion 134. The upwardly curved portion 134 levels out and terminates in the barb 136 at a level essentially in-line with the straight portion 130. In other words, the barb 136 ends up substantially level with the straight portion 130.

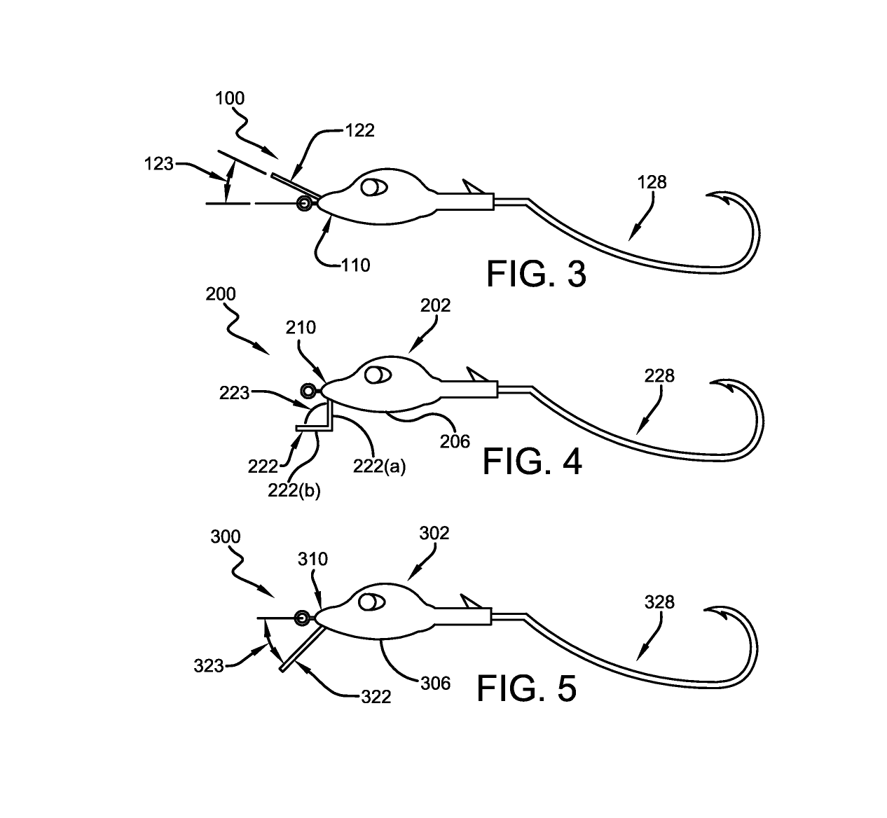

As illustrated in FIG. 3, the lip 120 of the snake-shaped jig head 102 extends forward from the front portion 108 creating an upward angled lip 122. The upward angled lip 122 extends from the top 104 of the front portion 108 at an angle 123 of approximately between ten and forty five degrees. The upward angled lip 122 allows the artificial bait device 100 to essentially float on the surface of the water when reeled.

FIG. 4 illustrates an embodiment of an artificial bait device 200 comprising a snake-shaped jig head 202, an angled lip 222 and a hook 228. The angled lip 222 comprises a downward angled portion 222(a) and a substantially level portion 222(b). The downward angled portion 222(a) extends from a bottom 206 of the snake-shaped jig head 202. The substantially level portion 222(b) then extends forward from the downward angled portion 222(a) at an angle 223 of approximately between ninety and one hundred ten degrees. The angled lip 222 allows the artificial bait device 200 to essentially sink shallowly into the water and then maintain a constant depth when reeled. The rest of the artificial bait device 200 is similar in construction to the previously depicted embodiment as described infra.

FIG. 5 illustrates an embodiment of an artificial bait device 300 comprising a snake-shaped jig head 302, a downward angled lip 322 and a hook 328. The downward angled lip 322 extends from a bottom 306 of the snake-shaped jig head 302 at an angle 323 of approximately between ten and forty five degrees. The downward angled lip 322 allows the artificial bait device 100 to essentially sink deeper into the water and then maintain a constant depth when reeled. The rest of the artificial bait device 300 is similar in construction to the previously depicted embodiment as described infra.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An artificial bait device comprising:
a snake-shaped jig head comprising a front portion, a middle portion, and a rear portion;
an upward angled lip extending from the front portion of the snake-shaped jig head;
a jig skirt extending from the rear portion of the snake-shaped jig head; and
a hook comprising a straight portion protruding from and extending rearwardly from the rear portion of the snake-shaped jig head, a downwardly angled portion, and an upwardly curved portion terminating in a barb.

2. The artificial bait of claim 1, wherein the front portion of the snake-shaped jig head is flatter than the middle portion.

3. The artificial bait of claim 2, wherein the front portion of the snake-shaped jig head is narrower than the middle portion.

4. The artificial bait of claim 3, wherein the front portion of the snake-shaped jig head is beveled.

5. The artificial bait of claim 1, wherein the jig skirt comprises a spinning element.

6. The artificial bait of claim 1, wherein the barb of the hook is substantially level with the straight portion of the hook.

7. An artificial bait device comprising:
a snake-shaped jig head comprising a front portion, a middle portion, and a rear portion;
an angled lip comprising a downward angled portion extending from the front portion of the snake-shaped jig head, and a substantially level portion extending frontward from the downward angled portion;
a jig skirt extending from the rear portion of the snake-shaped jig head; and
a hook comprising a straight portion protruding from and extending rearwardly from the rear portion of the snake-shaped jig head, a downwardly angled portion, and an upwardly curved portion terminating in a barb.

8. The artificial bait of claim 7, wherein the front portion of the snake-shaped jig head is flatter and narrower than the middle portion.

9. The artificial bait of claim 8, wherein the front portion of the snake-shaped jig head is beveled.

10. The artificial bait of claim 7, wherein the rear portion of the snake-shaped jig head comprises a bait attachment point.

11. The artificial bait of claim 7, wherein the substantially level portion of the angled lip extends at an angle substantially between 90 and 110 degrees from the downward angled portion.

12. The artificial bait of claim 7, wherein the jig skirt comprises a spinning element.

13. The artificial bait of claim 7, wherein the barb of the hook is substantially level with the straight portion of the hook.

14. An artificial bait device comprising:
a snake-shaped jig head comprising a front portion, a middle portion, and a rear portion;
a downward angled lip extending from the front portion of the snake-shaped jig head;
a jig skirt extending from the rear portion of the snake-shaped jig head; and
a hook comprising a straight portion protruding from and extending rearwardly from the rear portion of the snake-shaped jig head, a downwardly angled portion, and an upwardly curved portion terminating in a barb.

15. The artificial bait of claim 14, wherein the front portion of the snake-shaped jig head is flatter and narrower than the middle portion.

16. The artificial bait of claim 15, wherein the front portion of the snake-shaped jig head is beveled.

17. The artificial bait of claim 14, wherein the rear portion of the snake-shaped jig head comprises a bait attachment point.

18. The artificial bait of claim 14, wherein the downward angled lip extends approximately between 10 and 45 degrees.

19. The artificial bait of claim 14, wherein the jig skirt comprises a spinning element.

20. The artificial bait of claim 14, wherein the barb of the hook is substantially level with the straight portion of the hook.
